(19) United States
(12) Patent Application Publication
(10) Pub. No.: US 2007/0214223 A1
(43) Pub. Date: Sep. 13, 2007

(54) Electronic mail send program, electronic mail send device, and electronic mail send method

(75) Inventor: Yuri Morikubo, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/448,807

(22) Filed: Jun. 8, 2006

(30) Foreign Application Priority Data
Mar. 10, 2006 (JP) 2006-065453

(51) Int. Cl. G06F 15/16

(52) U.S. Cl. 709/206

(57) ABSTRACT

The present invention is to direct sender's attention to sending destination addresses and to prevent occurrence of missending of electronic mails. An electronic mail send program according to the present invention makes a computer execute: a determination step that determines whether or not a sending destination address specified for an electronic mail is a predetermined address; and an output step that displays a determination result thereof if the determination result of the determination step is positive, thereby to direct the user's attention to that the sending destination address is not wrong.

### BACKGROUND OF THE INVENTION

1. Field of the Invention

The present invention relates to a computer-readable medium storing an electronic mail send program, electronic mail send device, and an electronic mail send method, which prevents wrong sending of an electronic mail by letting the user to check that a sending destination address is correct when sending an electronic mail.

2. Description of the Related Art

A today's information device such as a personal computer (PC), PDA, or a mobile phone has a function to send an electronic mail and constitutes an electronic mail send device. In case of this electronic mail send device, a user specifies an address written in an address book of a mailer and presses down a send button. Then, a mail can be easily sent to the destination address.

Known as part of technology relevant to this prior art is an electronic mail send device by which the user can select an electronic mail address without problems even when the display part thereof is small, and can also select easily a desired electronic mail address in a very short time even when there are a very large number of received mails (for example, see Patent Document 1: Jpn. Pat. AppIn. Laid-Open Publication No. 2003-219016). Also known is another electronic mail send device which manages relationships to individual persons. This electronic mail send device prevents the user from becoming estranged from acquaintances or friends without cares taken by the user (for example, Patent Document 2: Jpn. Pat. Appln. Laid-Open Publication No. 2003-281050).

However, in this kind of electronic mail send device, sending destination addresses can be easily set and sent from an address book. This causes a risk that an unintended address may be set wrongly when selecting a sending destination address from the address book and the mail may be sent to the unintended address. In many cases, this kind of missending is left unaware unless who receives the mail gives an advice. Particularly when a business secret is sent to a private acquaintance at a similar address, a trouble may occur. Such missending is caused by sender's carelessness particularly when there are similar addresses.

### SUMMARY OF THE INVENTION

The present invention has been made to solve the problems described above, and has an object of providing an electronic mail send program, electronic mail send device, and electronic mail send method, which can directs sender's attention to sending destination addresses of electronic mails, to prevent missending of electronic mails.

To solve the above problems, according to the present invention, there is provided an electronic mail send program that sends an electronic mail and makes a computer execute: a determination step that determines whether or not a sending destination address specified as a destination to which an electronic mail is to be sent is a predetermined address; and an output step that outputs a notification concerning whether sending of the electronic mail may be allowed or not, based on a determination result made by the determination step.

The electronic mail send program according to the present invention further comprises an address setting step that sets a desired address, wherein the determination step determines whether or not the sending destination address is an address set by the address setting step, as the predetermined address.

In the electronic mail send program according to the present invention, the determination step determines whether or not the sending destination address is an address, as the predetermined address, of which a period from a time point when a previous electronic mail was sent using the sending destination address or a time point when an electronic mail addressed at the same receiving destination address as the sending destination address was received to the current time point has passed a set period.

In the electronic mail send program according to the present invention, the determination step determines whether or not the sending destination address is an address, as the predetermined address, which has a predetermined relationship with an address registered in an address book.

In the electronic mail send program according to the present invention, the determination step determines whether or not the sending destination address is an address which has a relationship of similarity to an address registered in the address book, as the predetermined relationship.

In the electronic mail send program according to the present invention, the relationship of similarity is based on spellings of addresses.

In the electronic mail send program according to the present invention, the determination step is executed when an instruction to send an electronic mail is given.

Also according to the present invention, there is provided an electronic mail send device for sending an electronic mail, comprising: a determination section that determines whether or not a sending destination address specified as a destination to which an electronic mail is to be sent is a predetermined address; and an output section that outputs a notification concerning whether sending of the electronic mail may be allowed or not, based on a determination result made by the determination section.

The electronic mail send device according to the present invention further comprises an address setting section that sets a desired address, wherein the determination section determines whether or not the sending destination address is an address set by the address setting section, as the predetermined address.

In the electronic mail send device according to the present invention, the determination section determines whether or not the sending destination address is an address, as the predetermined address, of which a period from a time point when a previous electronic mail was sent using the sending destination address or a time point when an electronic mail addressed at the same receiving destination address as the sending destination address was received to the current time point has passed a set period.

In the electronic mail send device according to the present invention, the determination section determines whether or not the sending destination address is an address, as the predetermined address, which has a predetermined relationship with an address registered in an address book.

In the electronic mail send device according to the present invention, the determination section determines whether or not the sending destination address is an address which has a relationship of similarity to an address registered in the address book, as the predetermined relationship.

In the electronic mail send device according to the present invention, the relationship of similarity is based on spellings of addresses.

In the electronic mail send device according to the present invention, the determination section is executed when an instruction to send an electronic mail is given.

Further, according to the present invention, there is provided an electronic mail send method that sends an electronic mail, to be executed by a computer, comprising: a determination step that determines whether or not a sending destination address specified as a destination to which an electronic mail is to be sent is a predetermined address; and an output step that outputs a notification concerning whether sending of the electronic mail may be allowed or not, based on a determination result made by the determination step.

According to the present invention, a senders attention can be directed to a sending destination address of a mail, with a simple structure, so that occurrence of missending of the electronic mail can be prevented. This can contribute to prevention of leakage of secret information by electronic mails and deterioration in communications.

### BRIEF DESCRIPTION OF THE DRAWINGS

FIG. 1 is a block diagram showing the overall structure of an information processing apparatus according to a first embodiment of the present invention;

FIG. 2 is a flowchart showing setting operation of the missending prevention function in the first embodiment;

FIG. 3 is an explanatory view conceptually showing the setting operation of the missending prevention function in the first embodiment;

FIG. 4 is a flowchart showing the operation of missending prevention function in the first embodiment;

FIG. 5 is a view showing an alarm indication in the first embodiment;

FIG. 6 is a flowchart showing setting operation of the missending prevention function in a second embodiment of the present invention;

FIG. 7 is an explanatory view conceptually showing setting operation of the missending prevention function in the second embodiment;

FIG. 8 is a flowchart showing operation of the missending prevention function in the second embodiment of the present invention;

FIG. 9 is a view of an alarm indication in the second embodiment; and

FIG. 10 is an explanatory view conceptually showing setting operation of the missending prevention function in a third embodiment.

### DETAILED DESCRIPTION OF THE PREFERRED EMBODIMENTS

Hereinafter, an embodiment of the present invention will be described as for an information processing apparatus having an electronic mail send device, with reference to the drawings.

FIG. 1 is a block diagram showing the overall structure of the information processing apparatus according to the present embodiment. This information processing apparatus 10 is applicable to any apparatus that has an electronic mail send device (electronic mail send function), including a PC, PDA, cellular phone or the like. This information processing apparatus 10 includes a CPU 1, ROM 2, RAM 3, operation section 4 including operation keys and a screen input section, display section 5, and an interface 6.

### First Embodiment

The first embodiment of the present invention will now be described. In the first embodiment, a user feels that plural address in an address book are similar to each other. When the user is going to select one address of those addresses as a sending destination address, the address is felt to be easily mistaken for another. In this case, if the user is going to send an electronic mail to such an address as a transmission destination address, a missending prevention mechanism works to invite the user to pay attention to the sending destination address.

For example, if two persons “Mr. Yamamoto” in a company and “Mr. Yamamoto” outside the company are registered in the address book, the missending prevention function is set to work with respect to the latter “Mr. Yamamoto” outside the company. Then, an alarm rings every time when “Mr. Yamamoto” outside the company is selected.

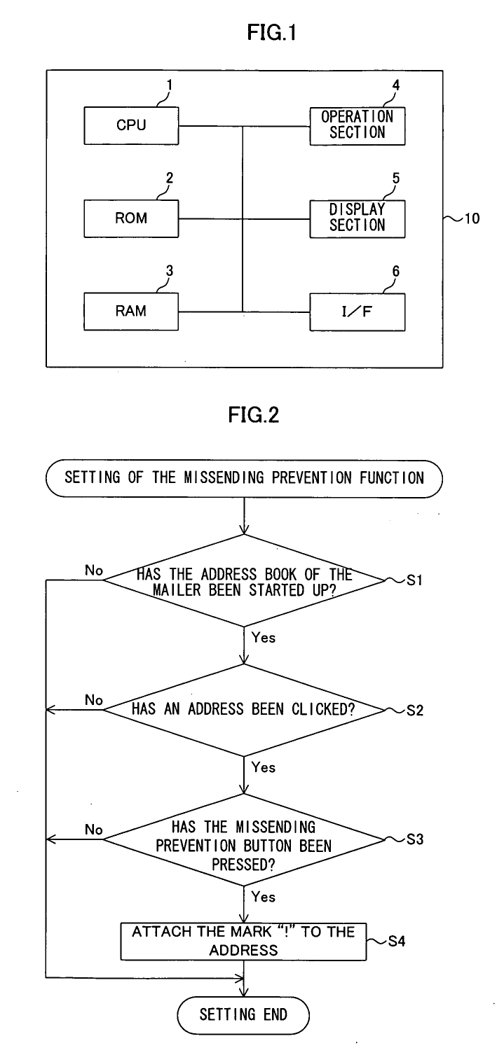

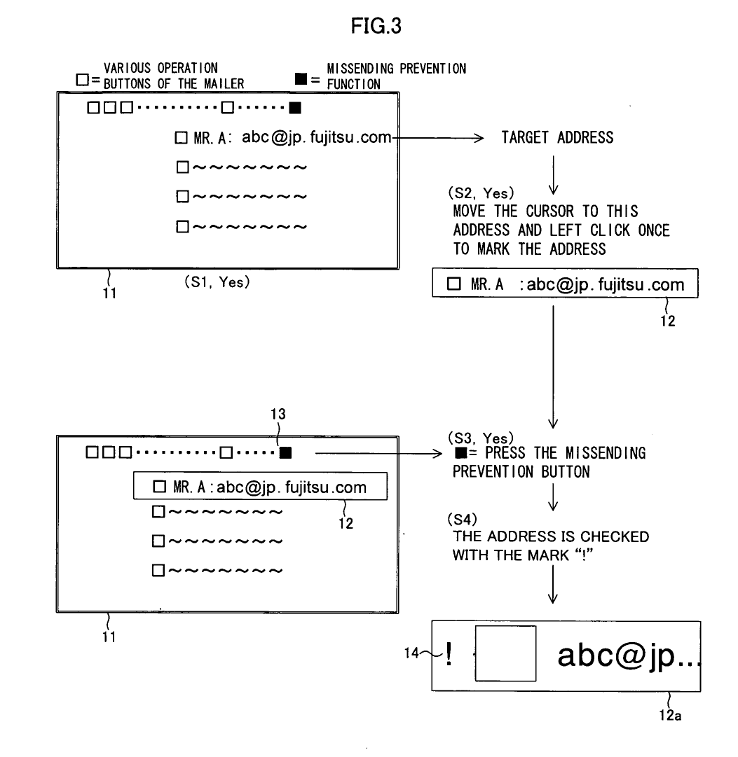

In the following, setting operation for the missending prevention mechanism in the operation of the first embodiment will be described specifically with reference to FIGS. 2 and 3. FIG. 2 is a flowchart showing setting operation of the missending prevention function. FIG. 3 is an explanatory view showing concepts of the operation. At first, as shown in FIG. 3, whether or not an address book 11 of a mailer has been activated is determined (step S1). If the address book has been activated (step S1, Y), whether or not an address 12 has been selected (clicked) by a user operation is determined (step S2), as shown in FIG. 3.

If an address is selected (step S2, Yes), whether or not a missending prevention button 13 has been pressed down is determined (step S3). If the missending prevention button 13 has been pressed down (step S3, Y), a check mark (for example, mark!) 14 is attached to an address 12a, and setting processing is terminated.

This missending prevention button 13 is equipped in the address book. Alternatively, the button 13 may be equipped on an electronic mail creation screen such that this button can be pressed down in the process of creating an electronic mail.

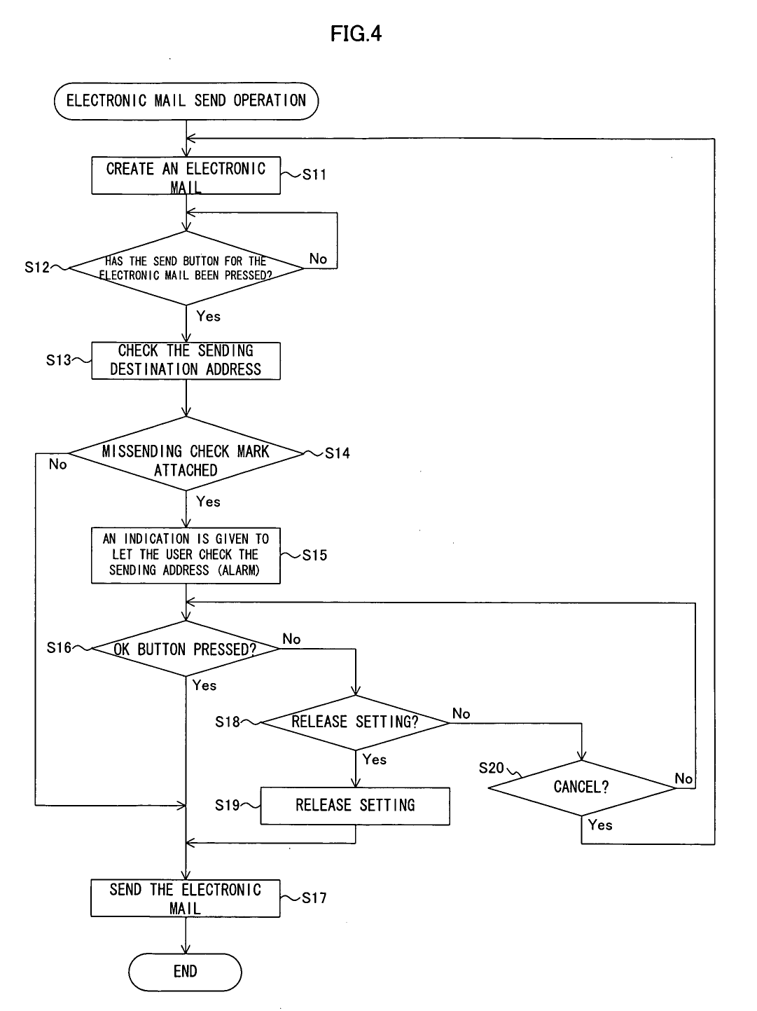

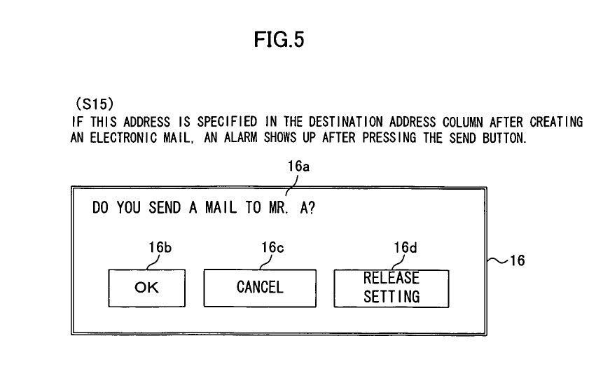

Next, operation of the missending prevention function when sending an electronic mail will be described specifically with reference to FIGS. 4 and 5. FIG. 4 is a flowchart showing the operation of the missending prevention function. FIG. 5 is an explanatory view showing concepts of the operation.

At first, an electronic mail is created (step S11), and whether or not an electronic mail send button has been pressed down is determined (step S12). If the send button has been pressed down (step S12, Yes), whether or not a sending destination address has been added with a check mark is checked (step S13). If a check mark has been added (step S14, Yes), the missending prevention function works, and displays, for example, an alarm 16 as shown in FIG. 5, as a confirmation indication to the user with respect to the sending destination address (step S15). If no check mark has been added (step S14, No), the electronic mail is sent intactly (step S17).

According to the alarm indication shown in FIG. 5, a question 16a asking whether or not the electronic mail can be sent now without changes is displayed, and an OK button 16b, a cancel button 16c, and a setting release button 16d are displayed.

Upon a confirmation by the user, the OK button 16b is pressed down (step S16, Yes), and the electronic mail is sent intactly (step S17). On the other side, if the setting release button 16d is pressed down (step S18, Yes), the setting is released and the electronic mail is intactly sent (step S17). As the setting release button 16d is pressed down, the missending prevention function is released, and the check mark is deleted from the address book. Further, if the cancel button 16c is pressed down (step S20, Yes), the processing returns to step S11.

According to the first embodiment, the user attaches a check mark to a sending destination address of an electronic mail which the user particularly pays attention to. In this way, when the user is going to send an electronic mail to the sending destination address, the missending prevention function works and attracts the user's attention, so occurrence of missending can be prevented. In the present embodiment, the missending prevention function to display an alarm indication is executed when the send button is pressed down. Needless to say, however, this function can be executed at the time when a sending destination address is inputted to an address column.

### Second Embodiment

The second embodiment is configured to invite the user to pay attention when the user is going to send an electronic mail to an address, as a sending destination address, an address which has not been addressed for a long time.

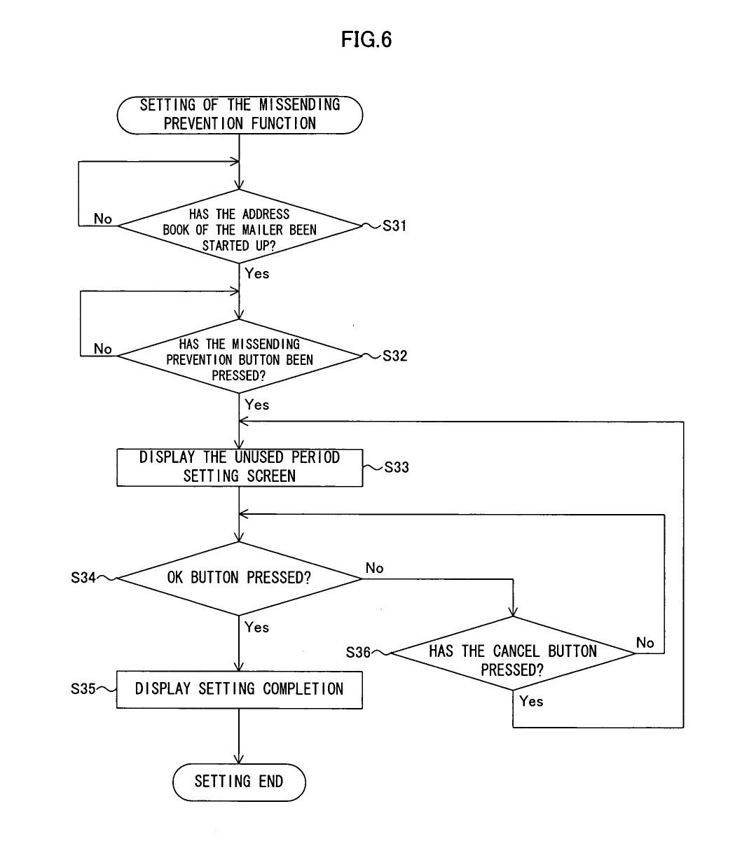

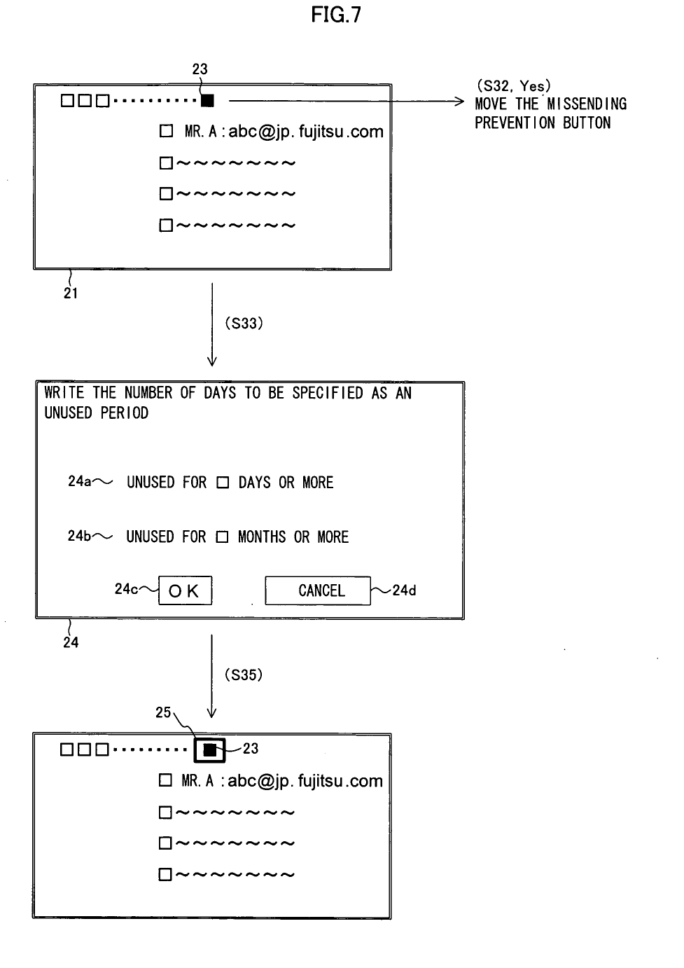

In the following, setting operation of the missending prevention mechanism in the operation of the second embodiment will be described specifically with reference to FIGS. 6 and 7. FIG. 6 is a flowchart showing setting operation of the missending prevention function. FIG. 7 is an explanatory view showing concepts of the operation.

At first, as shown in FIG. 7, whether or not an address book 21 of a mailer has been started up is determined (step S31). If the address book 21 has been started up (step S31, Yes), whether or not a missending prevention button 23 has been pressed is determined (step S32). If the missending prevention button has been pressed down (step S32, Yes), an unused period setting screen 24 is displayed (step S33).

The unused period setting screen 24 is provided with input columns 24a and 24b, an OK button 24c to be pressed down after inputting, and a cancel button 24d. The input columns 24a, 24b are to set how many days or more the address has not been used for or how many months or more the address has not been used for. The unused period setting screen 24 may be configured such that a message “input a number of press CANCEL” is displayed if the OK button 24c is pressed down with the columns kept not inputted (empty).

It the OK button 24c is pressed down on the screen after inputting a period (step S34, Yes), a setting completion indication is given (step S35). For example, the frame of the missending prevention button 23 is decorated by a bold line, so that the user can recognize setting completed.

Otherwise, if the cancel button 24d is pressed down in place of the OK button 24c (step S36, Yes), the processing returns to step S33.

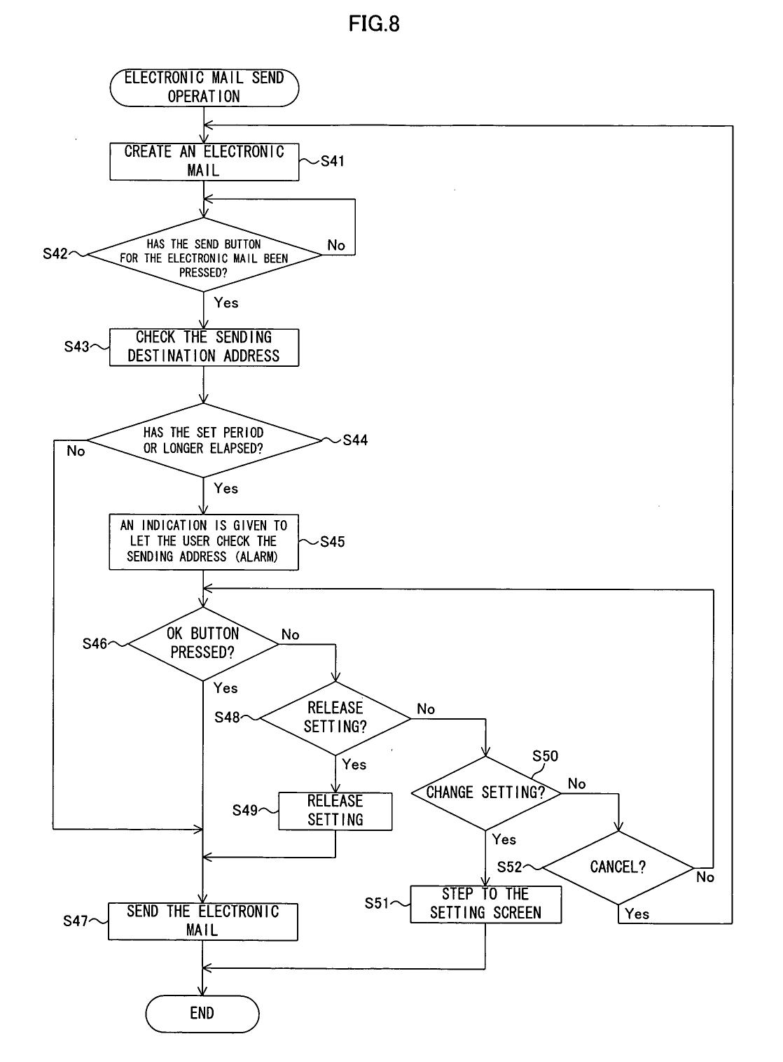

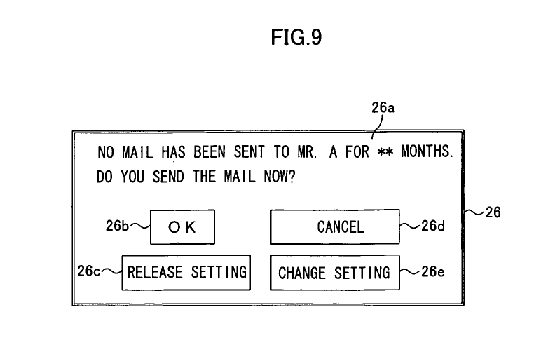

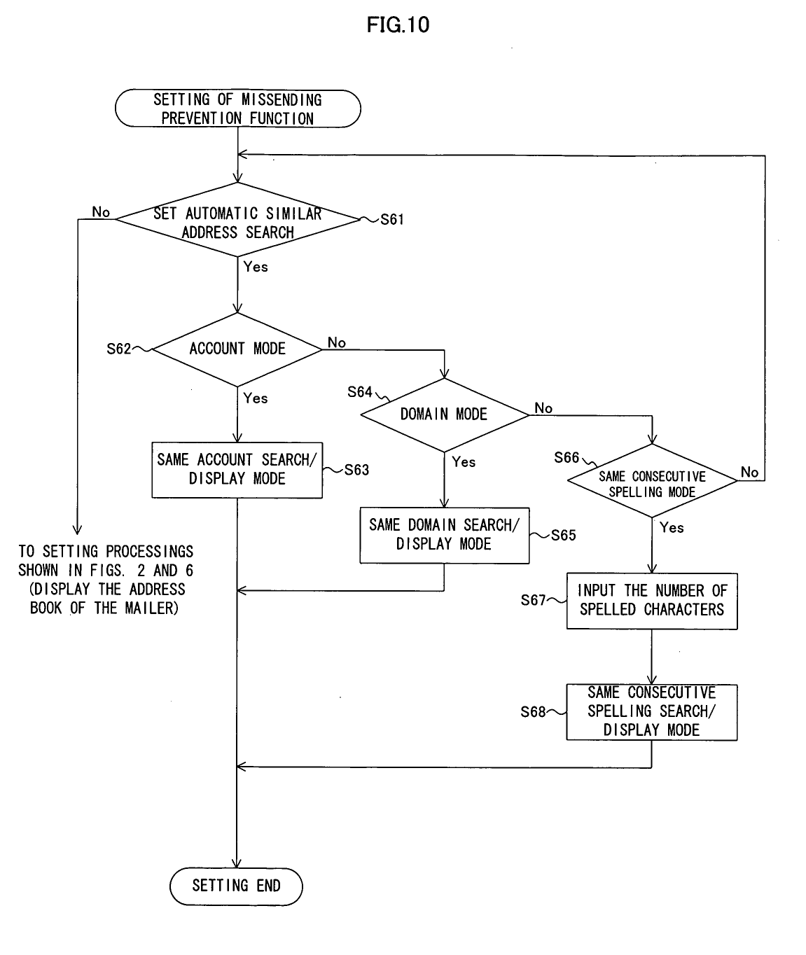

Next, operation of the missending prevention function at the time of sending an electronic mail will be described specifically with reference to FIGS. 8 and 9. FIG. 8 is a flowchart showing operation of the missending prevention function. FIG. 9 is an explanatory view showing concepts of the operation.

At first, an electronic mail is created (step S41). Whether or not a send button (not shown) for an electronic mail has been pressed down is determined (step S42). If the send button has been pressed down (step S42, Yes), whether or not the transmission destination address of the electronic mail has been unused for a set period is checked (step S43). If the address is determined as having been unused for a set period or longer (step S44, Yes), the missending prevention function works and displays an alarm 26, for example, as a confirmation indication to the user with respect to the sending destination address, as shown in FIG. 9 (step S45).

According to the alarm indication shown in FIG. 9, a question 26a asking whether or not the electronic mail can be sent now without changes is displayed, and an OK button 26b, a setting release button 26c, a cancel button 26d, and a setting change button 26e are displayed.

Upon a confirmation by the user, the OK button 26b is pressed down (step S46, Yes), the electronic mail is sent now without changes (step S47). On the other side, if the setting release button 26c is pressed down (step S48, Yes), the setting is released (step S49) and the electronic mail is intactly sent (step S47).

As the setting release button 26c is pressed down, the missending prevention function is released, and a period setting is released. If setting change button 26e is pressed down, the setting screen transits to the display step S33 (step S51). Further, if the cancel button 26d is pressed down (step S52, Yes), the processing returns to step S41.

According to the second embodiment, the missending prevention function works when the user is going to send an electronic mail, using a sending destination address of an electronic mail which the user has not used for a long time. The missending prevention mechanism then attracts the user's attention, so that occurrence of missending can be prevented. Like in the first embodiment, the missending prevention function to display an alarm is executed when the send button is pressed down, in the present embodiment. Alternatively, the missending prevention function may be executed at the time point when a sending destination address is inputted to an address column, needless to say.

### Third Embodiment

The first and second embodiments described above are based on addresses set by a user and unused periods. In addition, attention may be paid likewise when there is a similar address to a sending destination address, such as an address having the same account, the same domain, the same consecutive spelling, or the like.

FIG. 10 is a flowchart explaining setting operation according to the third embodiment. At first, the mailer is started up. Then, a similar address automatic setting button (not shown) is provided as a missending prevention button described in the first and second embodiments, or together with the button. Further, if this button is pressed down (step S61, Yes), whether or not an account mode has been selected is determined (step S62). In the account mode, the prevention function is let work in case of the same account. If this account mode has been selected (step S62, Yes) and if any address that has the same account as the sending destination address exists in the address book, the mode is set in which the address is searched for, and an alarm is displayed for each of those addresses (step S63).

Next, if a domain mode is selected (step S64, Yes) and if any address that has the same domain as the sending destination address exists in the address book, another mode is set (step S65). In this mode, the address is searched for and an alarm is displayed.

Otherwise, if a same consecutive spelling mode is selected (step S66, Yes), for example, the number of characters consecutively forming the same spelling as the spelling of the sending destination address is inputted (step S67). Further, when sending an electronic mail, if any address having the number of characters consecutively forming the same spelling as the spelling of the sending destination address, which has been set in step S67, exists in the address book, further another mode is set (step S68). In this further another mode, the address having the number of characters consecutively forming the same spelling is searched for, and an alarm is displayed.

According to the setting of the same consecutive spelling mode, an alarm is displayed also when an address having the same account or the same domain is registered in the address book, depending on the inputted number of spelled characters. In this embodiment, the number of spelled characters can be inputted and set in case of a spelling in which one character is spelled continuously repeatedly. However, a different mode may be set. In this mode, an alarm is displayed if only several equal spelled characters exist even though the equal spelled characters are not consecutive.

Operation concerning these alarms is the same as that described in the first embodiment. An alarm as shown in FIG. 5 may be displayed if a search is executed from the address book on the search condition in each mode and if an address which satisfies the condition is found in the address book, as a result. In the first to third embodiments, an alarm based on the missending prevention function is displayed on the screen. In place of the alarm or in combination with the alarm, an alarm sound may be outputted.

The embodiments of the present invention have been described above. Needless to say, however, the embodiments each may be configured such that any of the embodiments or a combination of the embodiments can be selected and set in one information processing apparatus.

In the embodiments of the present invention described above, steps shown in each flowchart may be stored in form of an electronic mail send program in a recording medium readable from a computer. In this way, the computer can be let execute the missending prevention function. In the present invention, the recording medium readable from a computer may include a portable storage medium such as a CD-ROM, flexible disk, DVD disk, magneto-optical disk, or IC card, a database which stores a computer program, another computer and a database thereof, or further a transfer medium on lines.

What is claimed is:

1. A computer-readable medium storing an electronic mail send program that sends an electronic mail and makes a computer execute:
a determination step that determines whether or not a sending destination address specified as a destination to which an electronic mail is to be sent is a predetermined address; and
an output step that outputs a notification concerning whether sending of the electronic mail may be allowed or not, based on a determination result made by the determination step.

2. The medium according to claim 1, wherein the program further making a computer execute an address setting step that sets a desired address, wherein the determination step determines whether or not the sending destination address is an address set by the address setting step, as the predetermined address.

3. The medium according to claim 1, wherein the determination step determines whether or not the sending destination address is an address, as the predetermined address, of which a period from a time point when a previous electronic mail was sent using the sending destination address or a time point when an electronic mail addressed at the same receiving destination address as the sending destination address was received to the current time point has passed a set period.

4. The medium according to claim 1, wherein the determination step determines whether or not the sending destination address is an address, as the predetermined address, which has a predetermined relationship with an address registered in an address book.

5. The medium according to claim 4, wherein the determination step determines whether or not the sending destination address is an address which has a relationship of similarity to an address registered in the address book, as the predetermined relationship.

6. The medium according to claim 5, wherein the relationship of similarity is based on spellings of addresses.

7. The medium according to claim 1, wherein the determination step is executed when an instruction to send an electronic mail is given.

8. An electronic mail send device that sends an electronic mail, comprising:
a determination section that determines whether or not a sending destination address specified as a destination to which an electronic mail is to be sent is a predetermined address; and
an output section that outputs a notification concerning whether sending of the electronic mail may be allowed or not, based on a determination result made by the determination section.

9. The electronic mail send device according to claim 8, further comprising an address setting section that sets a desired address, wherein the determination section determines whether or not the sending destination address is an address set by the address setting section, as the predetermined address.

10. The electronic mail send device according to claim 8, wherein the determination section determines whether or not the sending destination address is an address, as the predetermined address, of which a period from a time point when a previous electronic mail was sent using the sending destination address or a time point when an electronic mail addressed at the same receiving destination address as the sending destination address was received to the current time point has passed a set period.

11. The electronic mail send device according to claim 8, wherein the determination section determines whether or not the sending destination address is an address, as the predetermined address, which has a predetermined relationship with an address registered in an address book.

12. The electronic mail send device according to claim 11, wherein the determination section determines whether or not the sending destination address is an address which has a relationship of similarity to an address registered in the address book, as the predetermined relationship.

13. The electronic mail send device according to claim 12, wherein the relationship of similarity is based on spellings of addresses.

14. The electronic mail send device according to claim 8, wherein the determination section is executed when an instruction to send an electronic mail is given.

15. An electronic mail send method for sending an electronic mail, to be executed by a computer, comprising:
a determination step that determines whether or not a sending destination address specified as a destination to which an electronic mail is to be sent is a predetermined address; and
an output step that outputs a notification concerning whether sending of the electronic mail may be allowed or not, based on a determination result made by the determination step.

16. The electronic mail send method according to claim 15, further comprising an address setting step that sets a desired address, wherein the determination step determines whether or not the sending destination address is an address set by the address setting step, as the predetermined address.

17. The electronic mail send method according to claim 15, wherein the determination step determines whether or not the sending destination address is an address, as the predetermined address, of which a period from a time point when a previous electronic mail was sent using the sending destination address or a time point when an electronic mail addressed at the same receiving destination address as the sending destination address was received to the current time point has passed a set period.

18. The electronic mail send method according to claim 15, wherein the determination step determines whether or not the sending destination address is an address, as the predetermined address, which has a predetermined relationship with an address registered in an address book.

19. The electronic mail send method according to claim 18, wherein the determination step determines whether or not the sending destination address is an address which has a relationship of similarity to an address registered in the address book, as the predetermined relationship.

20. The electronic mail send method according to claim 19, wherein the relationship of similarity is based on spellings of addresses.
